(19) United States
(12) Patent Application Publication
(10) Pub. No.: US 2020/0272015 A1
(43) Pub. Date: Aug. 27, 2020

(54) ENHANCED CONTROL OF AN IGU WITH GRADED TINTING

(71) Applicant: SAGE ELECTROCHROMICS, INC., Faribault, MN (US)

(72) Inventor: Yigang Wang, Plymouth, MN (US)

(21) Appl. No.: 16/780,164

(22) Filed: Feb. 3, 2020

Related U.S. Application Data
(60) Provisional application No. 62/809,399, filed on Feb. 22, 2019.

(51) Int. Cl. G02F 1/163; G02F 1/155; G02F 1/153; E06B 9/24; E06B 3/67

(52) U.S. Cl. CPC G02F 1/163; G02F 1/155; G02F 1/1533; G02F 1/161; E06B 3/6722; G02F 2001/1555; E06B 9/24

(57) ABSTRACT

A method for controlling multiple electrochromic devices (ECDs) that have a variable tint profile. The method can include applying an initial test voltage profile to four or more bus bars of a first ECD, producing a first test tint profile in the first ECD in response to the initial test voltage profile, adjusting the initial test voltage profile to produce a first desired tint profile (DTP) in the first ECD, determining first modeling parameters based on the adjustments of the initial test voltage profile, modeling the first ECD based on the first modeling parameters, determining first compensation parameters via the first ECD model determining a first compensated voltage profile (CVP) by modifying the initial test voltage profile based on the first compensation parameters, and producing the first DTP in the first ECD in response to applying the first CVP to the first ECD.

### CROSS-REFERENCE TO RELATED APPLICATION(S)

This application claims priority under 35 U.S.C. § 119(e) to U.S. Provisional Application No. 62/809,399, entitled “ENHANCED CONTROL OF AN IGU WITH GRADED TINTING,” by Yigang WANG, filed Feb. 22, 2019, which is assigned to the current assignee hereof and incorporated herein by reference in its entirety.

### BACKGROUND

The present disclosure is directed to electroactive devices, and more specifically to apparatuses including electrochromic devices and method of using the same.

An electrochromic device can reduce the amount of sunlight entering a room or passenger compartment of a vehicle. Conventionally, an electrochromic device can be at a particular transmission state. For example, the electrochromic device may be set to a certain tint level (i.e. a percentage of light transmission through the electrochromic device), such as full tint (e.g. 0% transmission level), full clear (e.g. 63% +/−10% transmission level), or some tint level (or transmission level) in between the two. A glass pane may be formed with different discrete electrochromic devices, each controlled by its own pair of bus bars. The different electrochromic devices can each be set to a different tint level (i.e. % transmission state level). However, applying a voltage profile to one IGU to produce a tint level in the IGU does not mean that applying the same voltage profile to another IGU will produce a similar tint level. Further improvement in control regarding tinting of an electrochromic device is desired.

### BRIEF DESCRIPTION OF THE DRAWINGS

Embodiments are illustrated by way of example and are not limited in the accompanying figures.

FIG. 1A includes a representative top view of a substrate with bus bars, according to one embodiment.

FIG. 1B includes a representative cross-sectional view along line 1B-1B of a portion of a substrate of FIG. 1A, with a stack of layers for an electrochromic device (ECD) and bus bars, according to one embodiment.

FIG. 2 includes a representative cross-sectional view of an insulated glass unit (IGU) including an ECD, according to one embodiment.

FIGS. 3A-3D includes representative views of gradient tint profiles in an IGU, according to one embodiment.

FIG. 4 includes a representative top view of a substrate and bus bars showing a zonal separation line between top and bottom zones with representative current flows in the top and bottom zones indicated, according to one embodiment.

FIG. 5 includes a representative top view of a substrate and bus bars with an imaginary zonal separation line between top and bottom zones, with representative current flows in the top and bottom zones and between the top and bottom zones indicated, according to one embodiment.

FIG. 6 includes a representative top view of a substrate and bus bars with an imaginary zonal separation line between top and bottom zones, and Gradient Formation Leakage current flow between top and bottom zones indicated, according to one embodiment.

FIG. 7A includes a representative top view of a substrate and bus bars with the Gradient Formation Leakage current flow between top and bottom zones indicated, according to one embodiment.

FIG. 7B includes a representative plot of voltage signals for the bus bars of FIGS. 7A-7B with a representative voltage profile portion indicated, according to one embodiment.

FIG. 7C includes a schematic of an ECD model for the IGU of FIG. 7A, according to one embodiment.

FIG. 8 includes a representative functional block diagram of a test system for testing a percentage of light transmitted through the IGU, according to one embodiment.

FIG. 9 includes a representative functional block diagram of a main controller controlling multiple IGUs, according to one embodiment.

FIG. 10 includes a representative flow chart of example desired tint profiles of an ECD and transitions between the desired tint profiles, according to one embodiment.

FIG. 11 includes a representative functional block diagram of a controller of an IGU that models the ECD and controls voltage profiles that are transmitted to the ECD to produce a desired tint profile in the ECD, according to one embodiment.

FIG. 12 includes a representative flow chart of a method for characterizing an IGU using an ECD model and producing desired tint profiles in the ECD, according to one embodiment.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings.

As used herein, the terms “comprises,” “comprising,” “includes,” “including,” “has,” “having,” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

The use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise.

When referring to variables, the term “steady state” is intended to mean that an operating variable is substantially constant when averaged over 10 seconds, even through the operating variable may be change during a transient state. For example, when in steady state, an operating variable may be maintained within 10%, within 5%, or within 0.9% of an average for the operating variable for a particular mode of operation for a particular device. Variations may be due to imperfections in an apparatus or supporting equipment, such as noise transmitted along voltage lines, switching transistors within a control device, operating other components within an apparatus, or other similar effects. Still further, a variable may be changed for a microsecond each second, so that a variable, such as voltage or current, may be read; or one or more of the voltage supply terminals may alternate between two different voltages (e.g., V1 and V2) at a frequency of 1 Hz or greater. Thus, an apparatus may be at steady state even with such variations due to imperfections or when reading operating parameters. When changing between modes of operation, one or more of the operating variables may be in a transient state. Examples of such variables can include voltages at particular locations within an electrochromic device or current flowing through the electrochromic device.

The use of the word “about”, “approximately”, or “substantially” is intended to mean that a value of a parameter is close to a stated value or position. However, minor differences may prevent the values or positions from being exactly as stated. Thus, differences of up to ten percent (10%) for the value are reasonable differences from the ideal goal of exactly as described. A significant difference can be when the difference is greater than ten percent (10%).

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the glass, vapor deposition, and electrochromic arts.

An electrochromic device can be maintained in a continuously graded transmission state for nearly any time period, for example, such as beyond the time needed for switching between states. When continuously graded, the electrochromic device can have a relatively higher electrical field between bus bars at an area with relatively less transmission and a relatively lower electrical field between the bus bars at another area with relative greater transmission. The continuous grading allows for a more visibly pleasing transition between less transmission to greater transmission, as compared to discrete grading. The varying locations of the bus bars can provide voltages that can range from fully clear (highest transmission or fully bleached) to fully tinted (lowest transmission state), or anything in between. Still further, the electrochromic device can be operated with a substantially uniform transmission state across all of the area of the electrochromic device, with a continuously graded transmission state across all of the area of the electrochromic device, or with a combination of a portion with a substantially uniform transmission state and another portion with a continuously graded transmission state.

Many different patterns for the continuously graded transmission state can be achieved by the proper selection of bus bar location, the number of voltage supply terminals coupled to each bus bar, locations of voltage supply terminals along the bus bars, or any combination thereof. In another embodiment, gaps between bus bars can be used to achieve a continuously graded transmission state.

The electrochromic device can be used as part of a window for a building or a vehicle or other applications that can benefit from a controllable tinting, such as partitions that separate living spaces or office spaces. The electrochromic device can be used within an apparatus. The apparatus can further include an energy source, an input/output unit, and a control device that controls the electrochromic device. Components within the apparatus may be located near or remotely from the electrochromic device. In an embodiment, one or more of such components may be integrated with environmental controls within a building.

An electrochromic device can operate with voltages on bus bars being in a range of 0 V to 50 V. In one embodiment, the voltages can be between 0 V and 25 V. In another embodiment, the voltages can be between 0 V and 10 V. In yet another embodiment, the voltages can be between 0 V and 3 V. Such description is used to simplify concepts as described herein. Other voltages may be used with the electrochromic device, such as if the composition or thicknesses of layers within an electrochromic stack are changed. The voltages on bus bars may both be positive (0.1 V to 50 V), both negative (˜50 V to ˜0.1 V), or a combination of negative and positive voltages (-1 V to 2 V), as the voltage difference between bus bars are more important than the actual voltages. Furthermore, the voltage difference between the bus bars may be less than or greater than 50 V. Embodiments described herein are exemplary and not intended to limit the scope of the appended claims.

When controlling the tint profile of an electrochromic device (ECD) in an insulated glass unit (IGU), a voltage profile can be applied to the bus bars of the ECD to produce a desired tint level. Multiple voltage profiles can be determined that produce respective desired tint profiles in the ECD. Therefore, when a first set voltage profile (SVP) is applied to the bus bars, the ECD produces a first desired tint profile (DTP) and when a second SVP is applied to the bus bars, the ECD produces a second DTP. A DTP represents the tinting across an ECD that produces a desired light transmission profile across the ECD of the IGU. Each one of multiple DTPs can be fully clear (highest transmission or fully bleached) to fully tinted (lowest transmission state), or anything in between. The DTP can also be a substantially uniform transmission state across all of the area of the ECD, a continuously graded transmission state across all of the area of the ECD, or with a combination of a portion with a substantially uniform transmission state and another portion with a continuously graded transmission state.

However, performance parameters between ECDs can vary. This can partially be caused by varied physical characteristics and manufacturing tolerances between the ECDs. Therefore, if the first SVP, that produces a first DTP in a first ECD, is applied to a second ECD, the first DTP may not be produced in the second ECD. The first DTP can be achieved by adjusting the voltage profile applied to the second ECD away from the first SVP. However, this can cause problems for controlling multiple ECDs since the voltage profile for each ECD may need to be adjusted to produce the desired result (i.e. a DTP). Also, when one ECD is replaced by another ECD, the control of the ECD may need to be tailored to cause the new ECD to produce the same DTPs as the old ECD.

The current disclosure provides an IGU system with an ECD control method that alleviates or at least minimizes the issues of ECDs having varied performance characteristics. The IGU system and ECD control allows for a group of common SVPs to be created and when one of the SVPs are applied to any of the ECDs, the ECD will produce substantially the same DTP. For example, if a first SVP is applied to a first ECD, a first DTP is produced. Applying the same first SVP to a second ECD, the second ECD will also produce the first DTP. The current disclosure describes an ECD model that can emulate current flows in the ECD, establish unique compensation parameters for each ECD, and generate a compensated voltage profile (CVP) that, when applied to the ECD, produces the DTP.

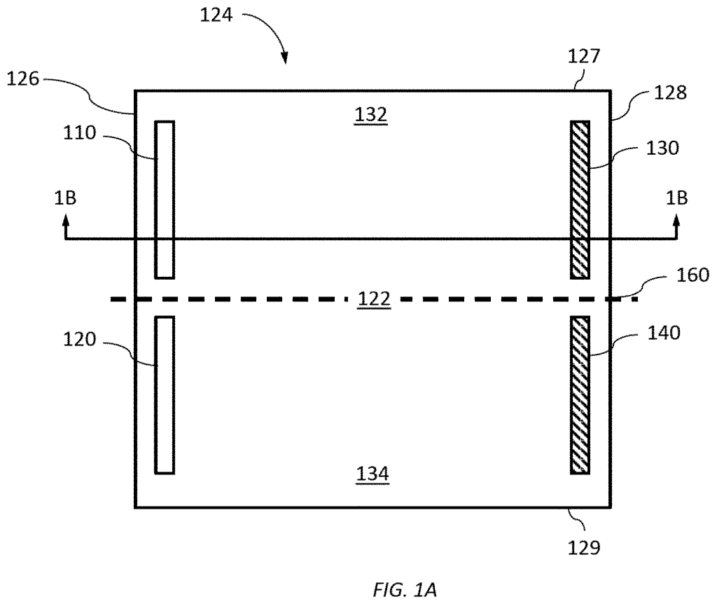

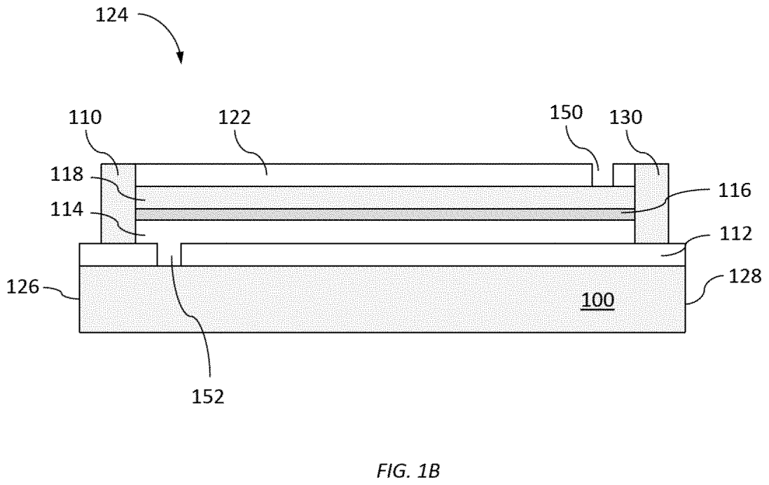

FIG. 1A includes an illustration of a top view of a rectangularly shaped ECD 124 with bus bars, according to one embodiment. In another embodiment, the ECD 124 can have a triangular shape with appropriate bus bar placement around a perimeter of the triangle. In another embodiment, the ECD 124 can have a polygonal shape with appropriate bus bar placement around a perimeter of the polygon. It should be understood that many variations of the ECD 124 can be used in keeping with the principles of this disclosure and that the embodiment shown in FIG, 1A is only one example of possible ECDs 124. Many various shaped IGUs and thus various shaped ECDs 124 are disclosed in the U.S. Provisional Patent Application No. 62/786,603 which is incorporated herein in its entirety by this reference and each of the IGUs, substrates, and ECDs, disclosed in this referenced provisional patent application can benefit from the aspects of this disclosure.

The ECD 124 can include a left side 126, a top 127, and right side 128, and a bottom 129. The ECD 124 can have a top zone 132 and a bottom zone 134 separated by a zonal separation line 160. The bus bars 130, 140 can be electrically connected to a first transparent conductive layer 112 (not shown), with the bus bars 110, 120 electrically connected to a second transparent conductive layer 122. A voltage potential between bus bars 110 and 130 can cause current to flow through the top zone 132, as where a voltage potential between bus bars 120 and 140 can cause current to flow through the bottom zone 134. The flow of current between the first and second transparent conductive layers 112, 122 can alter the tint profile of each zone 132, 134. A first voltage supply terminal V1 can set the voltage for the first bus bar 110, a second voltage supply terminal V2 can set the voltage for the second bus bar 120, a third voltage supply terminal V3 can set the voltage for the third bus bar 130, and a fourth voltage supply terminal V4 can set the voltage for the fourth bus bar 140.

FIG. 1B includes a representative cross-sectional view along line 1B-1B of a portion of the ECD 124 of FIG. 1A, with a stack of layers of ECD 124 and bus bars, according to one embodiment. The electrochemical device 124 can include a first transparent conductive layer 112, a cathodic electrochemical layer 114, an anodic electrochemical layer 118, and a second transparent conductive layer 122. The ECD 124 can also include an ion conducting layer 116 between the cathodic electrochemical layer 114 and the anodic electrochemical layer 118. The first transparent conductive layer 112 can be between the substrate 100 and the cathodic electrochemical layer 114. The cathodic electrochemical layer 114 can be between the first transparent conductive layer 112 and the anodic electrochemical layer 118. The anodic electrochemical layer 118 can be between the cathodic electrochemical layer 114 and the second transparent conductive layer 122.

The substrate 100 can include a glass substrate, a sapphire substrate, an aluminum oxynitride substrate, a spinel substrate, or a transparent polymer. In a particular embodiment, the substrate 100 can be float glass or a borosilicate glass and have a thickness in a range of 0.025 mm to 4 mm thick. In another particular embodiment, the substrate 100 can include ultra-thin glass that is a mineral glass having a thickness in a range of 10 microns to 300 microns. The first transparent conductive layer 112 and second transparent conductive layer 122 can include a conductive metal oxide or a conductive polymer. Examples can include a indium oxide, tin oxide or a zinc oxide, either of which can doped with a trivalent element, such as Sn, Sb, Al, Ga, In, or the like, or a sulfonated polymer, such as polyaniline, polypyrrole, poly(3,4-ethylenedioxythiophene), or the like or one or several metal layer(s) or a metal mesh or a nanowire mesh or graphen or carbon nanotubes or a combination thereof. The transparent conductive layers 112 and 122 can have the same or different compositions.

The cathodic electrochemical layer 114 and the anodic electrochemical layer 118 can be electrode layers. In one embodiment, the cathodic electrochemical layer 114 can be an electrochromic layer. In another embodiment, the anodic electrochemical layer 118 can be a counter electrode layer. The electrochromic layer can include an inorganic metal oxide electrochemically active material, such as WO₃, V₂O₅, MoO₃, Nb₂O₅, TiO₂, CuO, Ir₂O₃, Cr₂O₃, Co₂O₃, Mn₂O₃, or any combination thereof and have a thickness in a range of 20 nm to 2000 nm. The counter electrode layer can include any of the materials listed with respect to the electrochromic layer and may further include nickel oxide (NiO, Ni₂O₃, or combination of the two) or iridium oxide, and Li, Na, H, or another ion and have a thickness in a range of 20 nm to 1000 nm. The ion conductive layer 116 (sometimes called an electrolyte layer) can be optional, and can have a thickness in a range of 1 nm to 1000 nm in case of an inorganic ion conductor or 5 micron to 1000 microns in case of an organic ion conductor. The ion conductive layer 116 can include a silicate with or without lithium, aluminum, zirconium, phosphorus, boron; a borate with or without lithium; a tantalum oxide with or without lithium; a lanthanide-based material with or without lithium; another lithium-based ceramic material particularly LixMOyNz where M is one or a combination of transition metals or the like.

The third bus bar 130 can be electrically connected to the first transparent conductive layer 112. The first transparent conductive layer 112 can include portions 152 removed, so that the third bus bar 130 is not electrically connected to the first bus bar 110 via the first transparent conductive layer 112. Such removed portions 152 are typically 20 nm to 2000 nm wide. The first bus bar 110 can be electrically connected to the second transparent conductive layer 122. The second transparent conductive layer 122 can include portions 150 removed, so that the first bus bar 110 is not electrically connected to the third bus bar 130 via the second transparent conductive layer 122. The third bus bar 130 can be on the right side 128 of the stack of layers of the electrochemical device 124. The third bus bar 130 can be electrically connected to the cathodic electrochemical layer 114 via the first transparent conductive layer 112. The first bus bar 110 can be on the left side 126 of the stack of layers of the electrochemical device 124. The first bus bar 110 can be electrically connected to the anodic electrochemical layer 118 via the second transparent conductive layer 122.

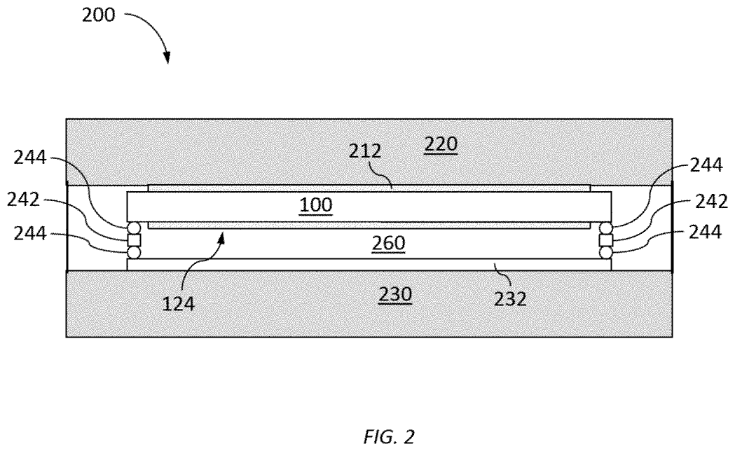

FIG. 2 includes an illustration of a cross-sectional view of an IGU 200 that includes an ECD 124 (for example the ECD as illustrated in FIGS. 1A, 1B). The IGU 200 can further include a counter substrate 220 and a solar control film 212 disposed between the substrate 100 of the ECD 124 and the counter substrate 220. The counter substrate 220 is coupled to a pane 230. Each of the counter substrate 220 and pane 230 can be a toughened or a tempered glass and have a thickness in a range of 2 mm to 9 mm. A low-emissivity layer 232 can be disposed along an inner surface of the pane 230. The low-emissivity layer 232 and the ECD 124 can be spaced apart by a spacer 242. The spacer bar 242 is coupled to the substrate 100 and low-emissivity layer 232 via seals 244. The seals 244 can be a polymer, such as polyisobutylene.

An internal space 260 of the IGU 200 may include a relatively inert gas, such as a noble gas or dry air. In another embodiment, the internal space 260 may be evacuated. The IGU can include an energy source, a control device, and an input/output (I/O) unit. The energy source can provide energy to the ECD 124 via the control device. In an embodiment, the energy source may include a photovoltaic cell, a battery, another suitable energy source, or any combination thereof. The control device can be coupled to the ECD 124 and the energy source. The control device can include logic to control the operation of the ECD 124. The logic for the control device can be in the form of hardware, software, or firmware. In an embodiment, the logic may be stored in a field programmable gate array (FPGA), an application-specific integrated circuit (ASIC), or another persistent memory. In an embodiment, the control device may include a processor that can execute instructions stored in memory within the control device or received from an external source. The I/O unit can be coupled to the control device. The I/O unit can provide information from sensors, such as light, motion, temperature, another suitable parameter, or any combination thereof. The I/O unit may provide information regarding the ECD 124, the energy source, or control device to another portion of the apparatus or to another destination outside the apparatus.

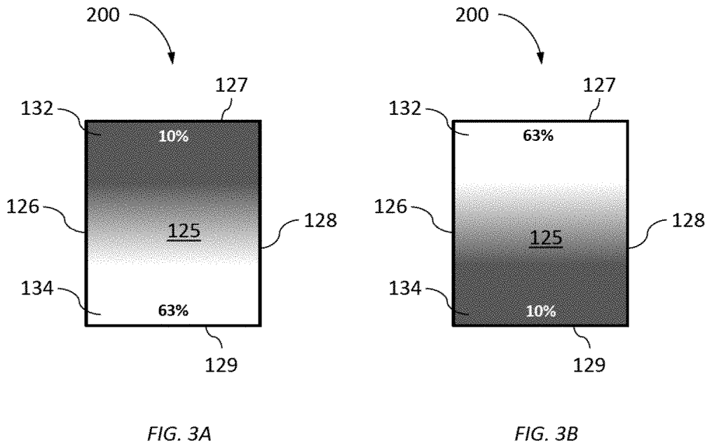

FIGS. 3A-3D includes representative examples of gradient tint profiles 125 in an IGU, according to one or more embodiments. These are merely examples of possible tint profiles 125. It should be understood that the tint profiles 125 can be fully clear (highest transmission or fully bleached) to fully tinted (lowest transmission state), or anything in between. The tint profile 125 can also be a substantially uniform transmission state across all of the area of the ECD in the IGU 200, a continuously graded transmission state across all of the area of the ECD, or with a combination of a portion with a substantially uniform transmission state and another portion with a continuously graded transmission state. FIG. 3A shows a gradient tint profile 125 that is partially tinted (10% transmission level) at the top 127 with a gradient tint from the 10% transmission level at the top 127 to a full clear (˜63% transmission level) at the bottom 129. FIG. 3B shows a gradient tint profile 125 that is opposite the one in FIG. 3A, having the partially tinted (10% transmission level) at the bottom129 with a gradient from the 10% transmission level at the bottom 129 to a full clear (˜63% transmission level) at the top 127. FIG. 3C shows a gradient tint profile 125 that is full tint (1% transmission level) at a bottom left corner of the IGU 200 with a gradient tint from the full tint at the bottom left corner to a full clear (˜63% transmission level) at the top right corner of the IGU 200. FIG. 3D shows a gradient tint profile 125 that is opposite the one in FIG. 3C, and shows a gradient tint profile 125 that is full tint (1% transmission level) at a top right corner of the IGU 200 with a gradient tint from the full tint at the top right corner to a full clear (˜63% transmission level) at the bottom left corner of the IGU 200.

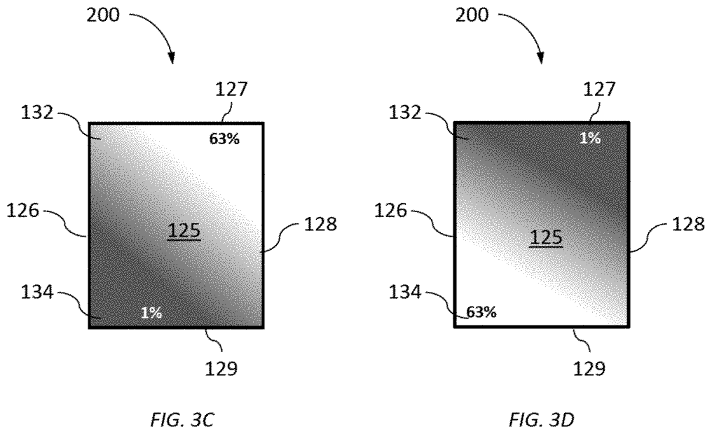

FIG. 4 includes an illustration of a top view of a rectangularly shaped ECD 124 with bus bars, according to one embodiment similar to the ECD 124 of FIG. 1A. In this example, a zonal separation line 160 can represent a laser cut that removes material of the ECD 124 along the separation line and prevents current flow between the top and bottom zones 132, 134. Therefore, potential differences between bus bars 110, 130 (or voltage supply terminals V1 and V3) can cause currents I1, 13 to travel between the bus bars 110, 130. The current I1 indicates current to or from the voltage supply terminal V1, with the current 13 indicating current to or from the voltage supply terminal V3. These currents I1, I3 should indicate the same direction and amount of current in this example, since the current enters and exits the top zone 132 via the voltage supply terminals V1, V3. Since the bus bar 130 can be electrically connected to the first transparent conductive layer 112 and the bus bar 110 can be electrically connected to the second transparent conductive layer 122, the current I1, I3 can travel through the ECD 124 in the top zone 132 to control the tint level of the top zone 132.

Potential differences between bus bars 120, 140 (or voltage supply terminals V2 and V4) can cause currents I2, 14 to travel between the bus bars 120, 140. The current 12 indicates current to or from the voltage supply terminal V2, with the current 14 indicating current to or from the voltage supply terminal V4. These currents I2, I4 should indicate the same direction and amount of current in this example, since the current enters and exits the bottom zone 134 via the voltage supply terminals V2, V4. Since the bus bar 140 can be electrically connected to the first transparent conductive layer 112 and the bus bar 120 can be electrically connected to the second transparent conductive layer 122, the current 12, 14 can travel through the ECD 124 in the top zone 132 to control the tint level of the top zone 132. It should be understood that the bus bars 110, 120, 130, 140 can be electrically connected to the first and second transparent conductive layers 112, 122 in various other configurations in keeping with the principles of the current disclosure. For example, the bus bars 110, 120 can be electrically connected to the first transparent conductive layer 112, with the bus bars 130, 140 electrically connected to the second transparent conductive layer 122.

The optional conductors 162, 164, 166, 168 can be used to connect the top and bottom zones 132, 134 in parallel, if desired, but current does not pass between the top and bottom zones 132, 134, across the zonal separation line 160 in the ECD 124, in this example.

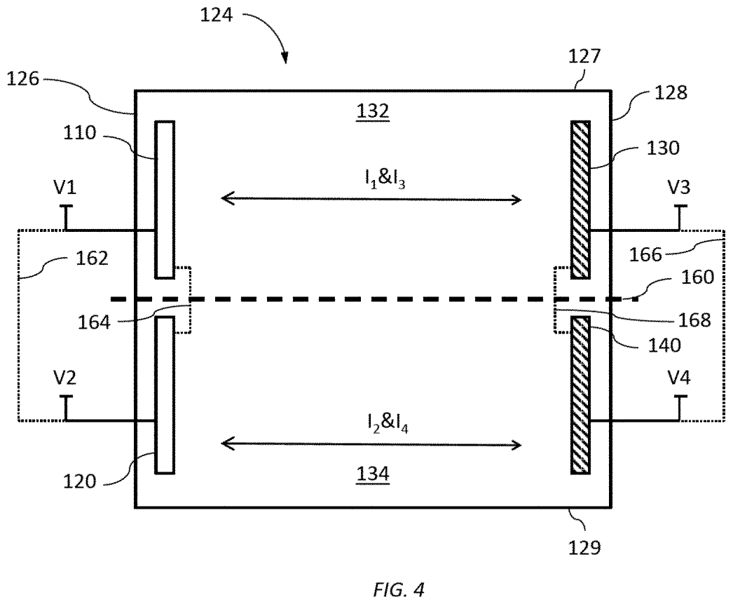

FIG. 5 includes a representative top view of a substrate and bus bars with an imaginary zonal separation line 160 separating the top and bottom zones 132, 134, with representative current flows in the top and bottom zones 132, 134 and between the top and bottom zones 132, 134 indicated, according to one embodiment. Currents I1, I2, I3, I4 to and from the respective voltage supply terminal V1, V2, V3, V4 can flow toward any of the other three voltage supply terminals, since the zonal separation line 160 is imaginary only and no material of the ECD 124 is removed along the line 160 allowing current to flow between top and bottom zones 132, 134 through the transparent conductive layers 112, 122. Potential differences between bus bars 110, 120, 130, 140 (or voltage supply terminals V1, V2, V3, V4) can cause currents I1, I2, I3, I4 to travel between the bus bars 110, 120, 130, 140.

The current I1 indicates current to or from the voltage supply terminal V1, the current I2 indicates current to or from the voltage supply terminal V2, the current I3 indicates current to or from the voltage supply terminal V3, and the current 14 indicates current to or from the voltage supply terminal V4. Since the bus bars 130, 140 can be electrically connected to the first transparent conductive layer 112 and the bus bars 110, 120 can be electrically connected to the second transparent conductive layer 122, the currents I1, I2, I3, I4 can travel through the transparent conductive layers 112, 122 of the ECD 124 across top and bottom zones 132, 134 to control the tint level (or tint profile) of the ECD 124. Voltage signals applied to the voltage supply terminals V1, V2, V3, V4 can be adjusted to produce the desired voltage differences across the ECD 124 and thereby produce a desired tint profile (DTP). However, as stated above, if the same voltage signals (or voltage profile) are applied to the voltage supply terminals V1, V2, V3, V4 of a second ECD 124, the second ECD 124 may not produce the DTP as they did in the first ECD 124, due to variations (e.g. physical variations, manufacturing tolerances, etc.) between the two ECDs 124. The current disclosure describes a system and method for controlling multiple ECDs such that each of the ECDs will produce substantially the same DTP when an SVP is applied to each of the ECDs. This same process can also be used for ECDs 124 with more than four bus bars to produce a desired tint profile (DTP) in an IGU 200.

In ECDs 124 with zones (such as top and bottom zones 132, 134) that are electrically isolated from each other as in FIG. 4 above, the charge (or current) flowing through each zone can be easily monitored, measured and determined by sensors measuring voltage and current at the voltage supply terminals. However, when the zones are electrically connected to each other via the first and second transparent conductive layers 112, 122, then measuring the charge (or current) flow through the ECD zones can be much more troublesome. For example, current and voltage readings at a voltage supply terminal, such as V2, would not necessarily determine the contributions of the current flow from the other voltage supply terminals, such as V1, V3, V4, from these readings because the current flow can include various contributions from any of the other voltage supply terminals of the ECD 124.

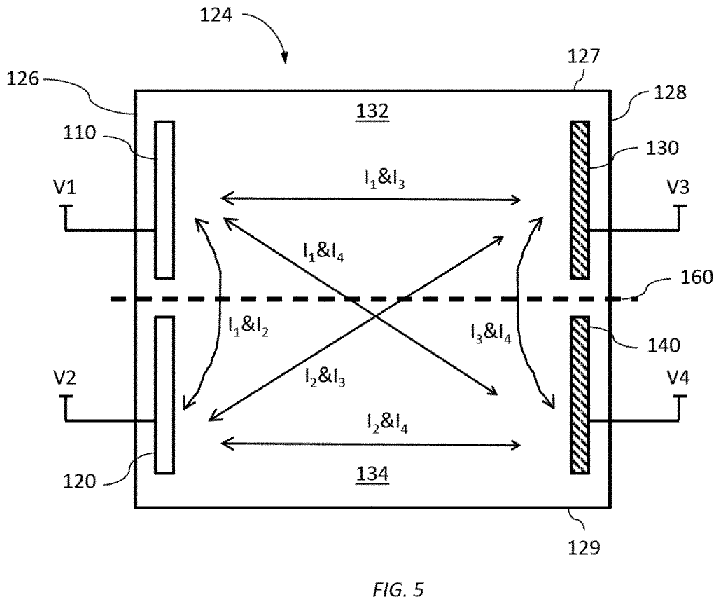

FIG. 6 includes a representative top view of a substrate and bus bars with an imaginary zonal separation line 160 between top and bottom zones 132, 134, with current flow between the top and bottom zones 132, 134 being indicated, according to one embodiment. The current disclosure provides a method and process for estimating the amount of charge (or current) that flows between the top and bottom zones 132, 134, which is referred to as a Gradient Formation Leakage (GFL) current. By estimating GFL current in an ECD 124, a desired voltage profile can be determined that should produce a desired tint profile (DTP) in the ECD 124.

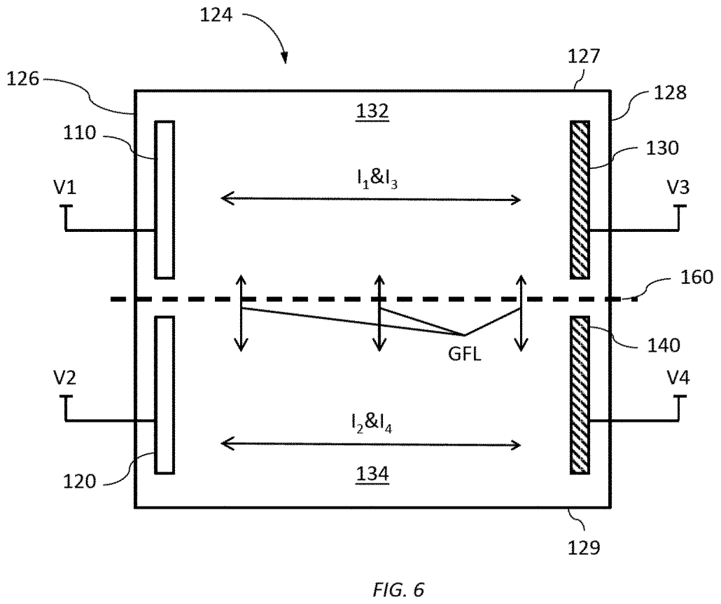

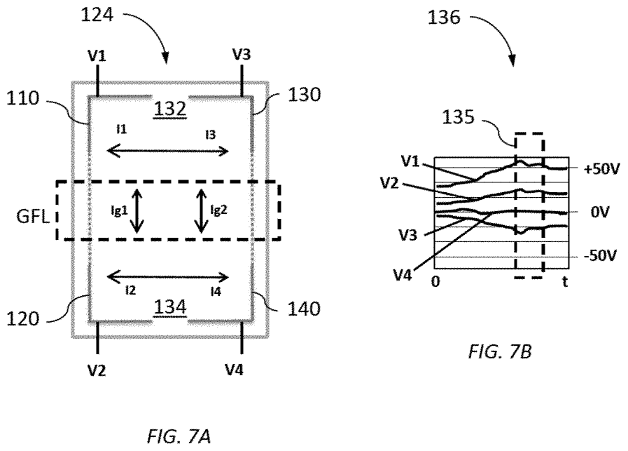

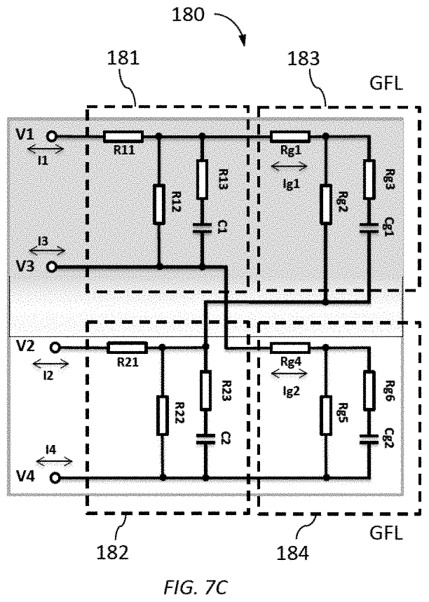

FIG. 7A includes a representative top view of a substrate and bus bars of an ECD 124 with the GFL current flow (currents Ig1, Ig2) between top and bottom zones being indicated, according to one embodiment. Please note that the bus bar configuration of the ECD 124 is slightly different than the bus bar configuration shown in FIG. 6. This illustrates that various bus bar configurations can be used in keeping with the principles of this disclosure.

FIG. 7B includes a representative plot of voltage signals for the bus bars of an ECD 124 with a representative voltage profile portion indicated, according to one embodiment. As used herein, a “voltage profile” includes a voltage signal for each of the bus bars in an ECD 124. The voltage signal can a voltage value applied to a bus bar over a span of time, where the voltage value can change during the span of time. The plot 136 shows representative voltages plotted from time “0” to time “t” for each of the voltage supply terminals V1, V2, V3, V4 of the ECD in FIG. 7A. A portion of the voltage plots is indicated by the dashed rectangle 135, which can represent a “voltage profile” 135 that includes values of a voltage for each of the voltage supply terminals V1, V2, V3, V4 during a span of time, such as the span in FIG. 7Bthat is a subset of the time from “0” to “t.” Therefore, when this disclosure refers to a “voltage profile,” it refers to a group of voltage signals (one voltage signal for each voltage supply terminal such as 4 voltage signals for 4 voltage supply terminals, 6 voltage signals for 6 voltage supply terminals, 8 voltage signals for 8 voltage supply terminals, 9 voltage signals for 9 voltage supply terminals, etc.), where each voltage signal can include a variable voltage over time. Each voltage signal can include spikes in the voltage value, which can be used to achieve a tint level in the ECD 124 faster than if the spike was not used. The spike can be positive or negative, which can depend upon the tint profile to which the ECD is transitioning as well as the tint profile from which the ECD is transitioning.

FIG. 7B includes a schematic of an ECD model 180 for the ECD 124 of FIG. 7A, according to one embodiment. In this embodiment, the ECD model 180 is a representative circuit of equivalent impedances that models the characteristics of an ECD 124. The ECD model 180 can include an equivalent impedance network between pairs of bus bars. The ECD model 180 can model relationships between voltages applied to the voltage supply terminals V1, V2, V3, V4 and the currents I1, I2, I3, I4, Ig1, Ig2. The ECD model 180 shown in FIG. 7C is configured to model the 4 bus bar ECD that is similar to the one shown in FIG. 7A. If additional bus bars are used in the ECD, then impedance networks can be added, deleted, or modified as needed to correctly model the ECD.

In this example, the networks 181, 182, 183, 184 generally model the ECD. The network 181 can include resistors R11, R12, R13, and a capacitor Cl connected as shown to model the portion of the ECD between the voltage supply terminals V1 and V3. The network 182 can include resistors R21, R22, R23, and a capacitor C2 interconnected in the model as shown to model the portion of the ECD between the voltage supply terminals V2 and V4. The network 183 can include resistors Rg1, Rg2, Rg3, and a capacitor Cg1 connected as shown to model the portion of the ECD between the voltage supply terminals V1 and V2. The network 184 can include resistors Rg4, Rg5, Rg6, and a capacitor Cg2 connected as shown to model the portion of the ECD between the voltage supply terminals V3 and V4. The networks 183, 184 can be used to determine the Gradient Formation Leakage (GFL) current flowing between the top and bottom zones 132, 134.

It may be desirable to establish a group of set voltage profiles (SVPs) that produce standard desired tint profiles (DTPs) in multiple ECDs. Applying a first SVP to any of the multiple ECDs would result in a first DTP substantially being produced in the ECD, applying a second SVP to any of the multiple ECDs would result in a second DTP substantially being produced in the ECD, applying a third SVP to any of the multiple ECDs would result in a third DTP substantially being produced in the ECD, and so on. By standardizing the SVPs across multiple ECDs for producing the respective DTPs in those ECDs, complexity of controlling the multiple ECDs can be reduced.

The resistors R11, R12, R13, R21, R22, R23, Rg1, Rg2, Rg3, Rg4, Rg5, Rg6, and capacitors C1, C2, Cg1, Cg2 can be referred to as ECD modeling parameters. These components may make the framework of the model 180, but the values of these modeling parameters tailor the model 180 to one of the ECDs such that the model 180 correctly models the ECD. Characterizing the ECD refers to a process that is used to determine the values of the modeling parameters for an ECD. With initial values for the modeling parameters, a first SVP can be input to the model 180 inputs V1, V2, V3, V4 and the model can output a test voltage profile that can be applied to the voltage supply terminals (e.g. V1, V2, V3, V4 of the ECD to produce a test tint profile across the ECD. The test voltage profile can equal the first SVP initially. The test tint profile may not be equal to the first DTP, with the first DTP being the desired response of the ECD to the first SVP. The model 180 inputs V1, V2, V3, V4 can be adjusted until the ECD produces the first DTP across the ECD. Comparing the adjusted test voltage profile (which produces the first DVP in the individual ECD) to the first SVP and using the known initial values of the modeling parameters, unique modeling parameters for an individual ECD model can be determined. A temperature of the ECD or at least the surrounding environment of the ECD can be adjusted to simulate various environmental conditions when the test voltage profile is being applied to the ECD. This can improve accuracy of the ECD model by calculating the modeling parameters over varying environmental conditions.

The unique ECD model can then be used to determine compensation parameters for the individual ECD. The compensation parameters can be used to modify, in real time, a voltage profile applied to the ECD such that SVPs substantially produce a respective DTP for each SVP across the ECD.

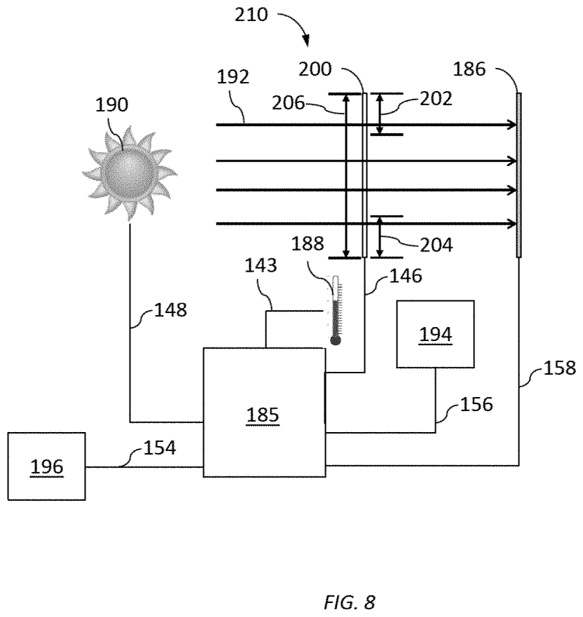

FIG. 8 includes a representative functional block diagram of a test setup 210 for testing a percentage of light transmitted through the IGU, according to one embodiment. The test setup 210 can be used to test the % transmission of light through the IGU 200 A test controller 185 can be coupled to various elements of the test setup 210 to characterize the ECD 124 of the IGU 200. The test setup 210 can include a light source 190, a user interface 196, a temperature sensor 188, an environment controller, and a photo sensor that can be an array or a single optical sensor. The test controller 185 can control the light source 190 via the line 148 to illuminate the IGU 200 with light signals 192. The light signals 192 can be transmitted through the IGU 200 and received by a photosensor 186. The photosensor 186 can be an array of light sensors to detect a % transmission profile (i.e. tint profile) of the light signals 192 through the IGU 200. Alternatively, or in addition to, the photosensor 186 can be smaller than the IGU under test and may need to be moved around the IGU 200 to take photosensor readings of the light signals that are transmitted through the IGU 200. The photosensor 186 can communicate its sensor data to the test controller 185 via the line 158. Voltage profiles can be applied to the IGU 200 via the line (or lines) 146. A temperature sensor 188 can provide continuous, periodic, or random updates via line 143 to the test controller 185 during the testing. The test controller 185 can control, or receive data from, an environmental controller 194 via line 156, where the environmental controller 194 can adjust the environmental temperature by controlling climate control equipment (e.g. an A/C unit or heater). Test parameters can be provided via a line 154 from a user interface 196 that allows a user to direct the test operation via commands and data transmitted to the test controller 185. A length 202 at the top of the IGU can be ˜20% of the length 206 of the IGU. A length 204 at the bottom of the IGU can be ˜20% of the length 206 of the IGU.

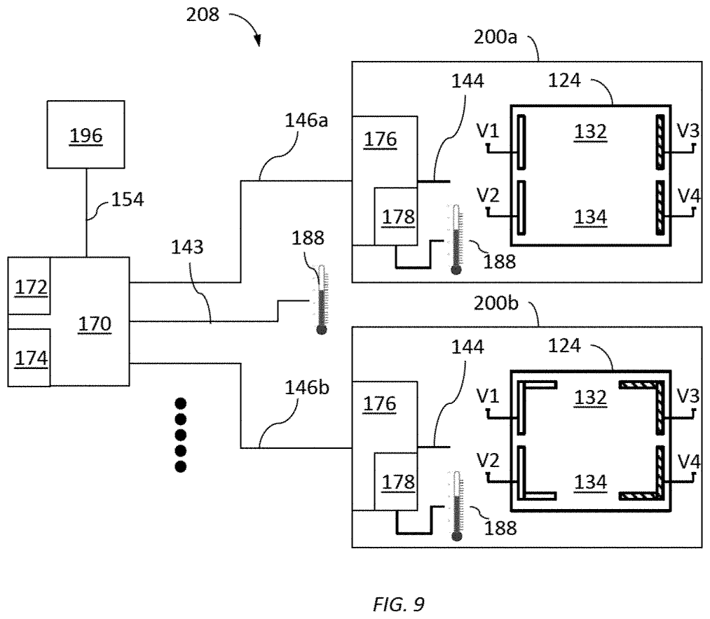

FIG. 9 includes a representative functional block diagram of a main controller 170 for controlling multiple IGUs 200a, 200b in an IGU system 208, according to one embodiment. Only two IGUs 200a, 200b are shown, but more IGUs can be controlled by the main controller 170 as indicated by the dotted line. The main controller 170 can include a non-transitory memory 172 for storing various information of the IGU system that can include executable commands of a software program. The executable program commands can instruct the main controller 170 to perform at least a portion of the methods and processes described in this disclosure. The main controller 170 can also include a non-transitory memory 174 for storing SVPs. The memories 172, 174 can be combined into one non-transitory memory, and they can also be included in one or more processors of the main controller 170. The SVP memory 174 can contain a group of SVPs which the main controller can read and transfer to a local IGU controller 176 over the control and data lines (e.g. lines 146a, 146b) in each of the IGUs 200. The main controller 170 can receive IGU control parameters from the user interface 196. The user interface 196 can include a computer with a monitor and keyboard to assist an operator in managing the IGU system 208 by directing the main controller 170.

The IGU system 208 can include one or more temperature sensors 188 to provide temperature readings that can be used to adjust the ECD models and the compensated voltage profiles (CVPs) for controlling tint profiles in the ECDs 124 of the IGUs 200a, 200b. There can be one or more temperature sensors 188 positioned external to the IGUs 200a, 200b for collecting environmental temperatures that can effect the performance of the ECDs 124. Alternatively, or in addition to, there can be one or more temperature sensors 188 internal to each IGU 200a, 200b. These internal temperature sensors 188 can transmit sensor data to the local IGU controller 176, which can then transmit the sensor data to the main controller 170. Alternatively, or in addition to, the local controller 176 can use the temperature information to adjust the ECD models 180 or the CVPs being applied to the ECDs 124. It is not a requirement that the temperature information is transmitted to the main controller 170. Alternatively, or in addition to, the internal temperature sensors 188 can transmit sensor data directly to the main controller 170. It is not a requirement that the temperature information be transmitted to the local IGU controller 176.

Each IGU 200a, 200b can include a local controller 176 that can also include a non-transitory memory for storing executable program commands. The executable program commands for the local IGU controller 176 can instruct the local controller 176 to perform at least a portion of the methods and processes described in this disclosure. The local IGU controller 176 can generate the CVPs and apply the CVPs to the ECD 124 via the control lines 144. The control lines 144 can be connected the voltage supply terminals V1, V2, V3, V4 to cause the ECD 124 to produce the DTPs. The local controller 176 can also include an energy source for generating the voltage profiles, including the CVPs. The energy source can be a battery system, a photovoltaic cell system, an electrical generator system, or receiving power inputs from the main controller 170.

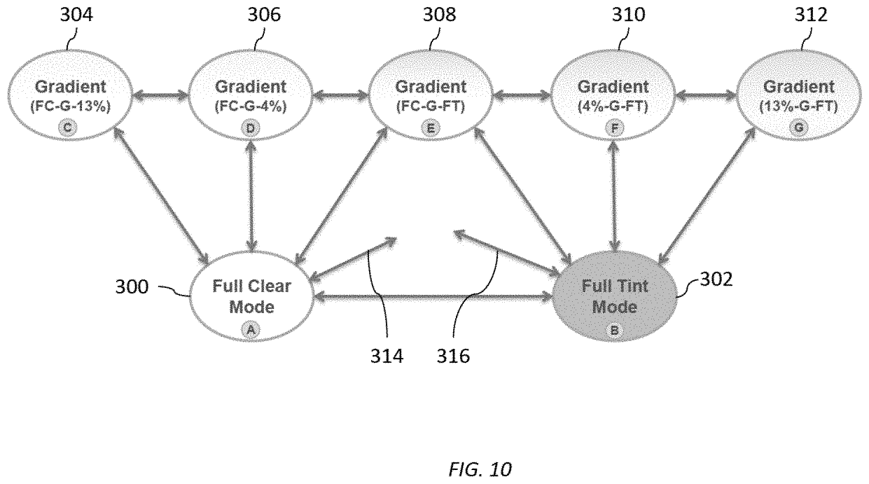

FIG. 10 includes a representative flow chart of example desired tint profiles (DTPs) of an ECD and possible transitions between the DTPs, according to one embodiment. The flow chart includes the desired tint profiles 300, 302, 304, 306, 308, 310, 312. It should be understood that these are only exemplary DTPs and more or fewer DTPs are possible in keeping with the principles of this disclosure. Additionally, for discussion purposes, these DTPs are relating to a rectangular ECD 124 with a gradient (if present) from top to bottom or bottom to top of the ECD 124, as shown in FIGS. 3A-3B. However, the DTPs can also be established for other shaped ECDs 124, such as triangular, circular, polygonal, trapezoidal, etc. The DTPs can also have diagonal gradients, as shown in FIGS. 3C-3D. Table 1 below indicates the tint profile associated with the particular DTP #, as well as the possible area of coverage of the tinting in the desired tint profile (DTP).

TABLE 1

| DTP # | Tint Profile | Area coverage |
|---|---|---|
| DTP 300 | Full clear (FC) | Full ECD viewable area |
| DTP 302 | Full tint (FT) | Full ECD viewable area |
| DTP 304 | FC to 13% T | FC within 20% length from top |
| | | 13% T within 20% length from bottom |
| DTP 306 | FC to 4% T | FC within 20% length from top |
| | | 4% T within 20% length from bottom |
| DTP 308 | FC to FT | FC within 20% length from top |
| | | FT within 20% length from bottom |
| DTP 310 | 4% to FT | 4% T within 20% length from top |
| | | FT within 20% length from bottom |
| DTP 312 | 13% to FT | 13% T within 20% length from top |
| | | FT within 20% length from bottom |

DTP 300 can be a full clear (FC) profile which indicates that the full viewable area of the ECD 124 is set to the highest transmission percentage of the ECD 124.

DTP 302 can be a full tint (FT) profile which indicates that the full viewable area of the ECD 124 is set to the lowest transmission percentage of the ECD 124.

DTP 304 can be a gradient tint profile from FC at a top end of the ECD 124 to 13% T tint level at a bottom end of the ECD 124. The DTP can be FC within the length 202 (i.e. 20% of the length of the ECD 124) from the top end to a 13% T tint level within the length 204 (i.e. 20% of the length of the ECD 124) from the bottom end.

DTP 306 can be a gradient tint profile from FC at a top end of the ECD 124 to 4% T tint level at the bottom end of the ECD 124. The DTP can be FC within the length 202 (i.e. 20% of the length of the ECD 124) from the top end to a 4% T tint level within the length 204 (i.e. 20% of the length of the ECD 124) from the bottom end.

DTP 308 can be a gradient tint profile from FC at a top end of the ECD 124 to FT at the bottom end of the ECD 124. The DTP can be FC within the length 202 (i.e. 20% of the length of the ECD 124) from the top end to FT within the length 204 (i.e. 20% of the length of the ECD 124) from the bottom end.

DTP 310 can be a gradient tint profile from 4%T tint level at a top end of the ECD 124 to FT at the bottom end of the ECD 124. The DTP can be FC within the length 202 (i.e. 20% of the length of the ECD 124) from the top end to a 4%T tint level within the length 204 (i.e. 20% of the length of the ECD 124) from the bottom end.

DTP 312 can be a gradient tint profile from 13%T tint level at a top end of the ECD 124 to FT at the bottom end of the ECD 124. The DTP can be FC within the length 202 (i.e. 20% of the length of the ECD 124) from the top end to a 13%T tint level within the length 204 (i.e. 20% of the length of the ECD 124) from the bottom end.

The arrows connecting pairs of the tint profiles indicate a transition direction between the two DTPs at each end of the arrows. For example, the ECD can be commanded to transition between DTP 302 to DTP 308 and back again, if desired. The ECD can be commanded to transition between DTP 302 to DTP 308 and then transitioned from DTP 308 to another DTP. The ECD 124 can also be commanded to transition to DTPs that are not specifically indicated in FIG. 10, as representatively indicated by arrows 314 and 316. Arrows 314 indicate that the ECD can be commanded to transition between FC to any number of other DTPs. Arrows 316 indicate that the ECD can be commanded to transition between FT to any number of other DTPs.

The ECD 124 of the IGU 200 can transition between the DTP 300 (i.e. FC) and a gradient tint level with FC at the top end of the IGU 200 or ECD 124 to a 62%, 61%, 60%, 55%, 50%, 45%, 40%, 35%, 30%, 25%, 20%, 15%, 14%, 13%, 12%, 11%, 10%, 9%, 8%, 7%, 6%, 5%, 4%, 3%, 2%, or FT tint level at a bottom end of the IGU 200 or ECD. The top end can include a length 202 from the top of the IGU or ECD. The length 202 can be less than 20% of the length 206 of the IGU. The bottom end can include a length 204 from the bottom of the IGU. The length 204 can be less than 20% of the length 206 of the IGU.

The ECD 124 of the IGU 200 can transition between the DTP 302 (i.e. FT) and a gradient tint level with FT at the top end of the IGU 200 or ECD 124 to a 62%, 61%, 60%, 55%, 50%, 45%, 40%, 35%, 30%, 25%, 20%, 15%, 14%, 13%, 12%, 11%, 10%, 9%, 8%, 7%, 6%, 5%, 4%, 3%, or 2% tint level at a bottom end of the IGU 200 or ECD. The top end can include a length 202 from the top of the IGU or ECD. The length 202 can be less than 20% of the length 206 of the IGU. The bottom end can include a length 204 from the bottom of the IGU. The length 204 can be less than 20% of the length 206 of the IGU.

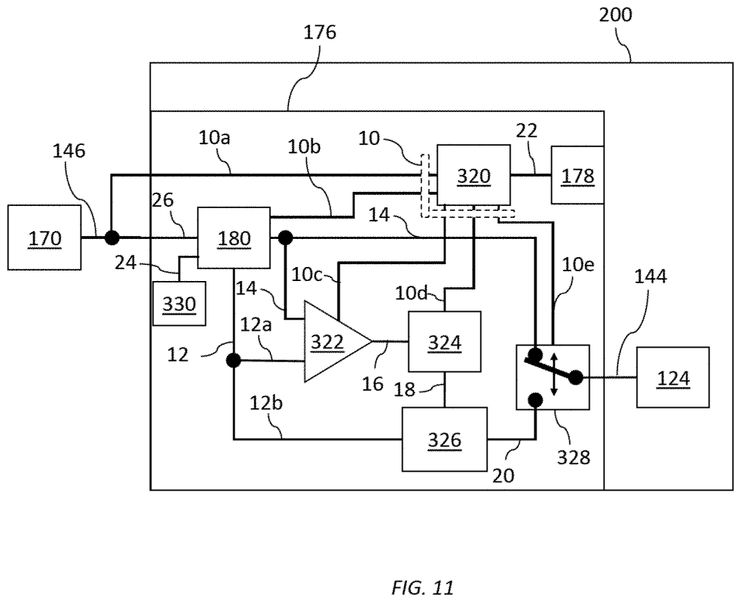

FIG. 11 includes a representative functional block diagram of an IGU controller 176 that can model the ECD and control voltage profiles that are transmitted to the ECD to produce a DTP, according to one embodiment. The main controller 170 can communicate with the IGU controller 176 via the command and control lines 146, which can also include power lines delivering electrical energy to the IGU 200. The IGU controller 176 can communicate with the ECD 124 to produce the DTP for the IGU 200. The IGU controller 176 can include an ECD model 180, an IGU processor 320, a comparator 322, a voltage compensation calculator 324, a voltage compensator 326, a voltage profile switch 328, an optional energy source 330, and a non-transitory memory 178.

The IGU controller 176 can include more or fewer elements than shown in FIG. 11, such as if some functions are combined into one functional block, or some functions are split into multiple functional blocks. The IGU processor 320 can include one or more processors, and the processor 320 can communicate to the other elements of the IGU controller 176, as well as the main controller 170, via control and data lines 10 (i.e. 10a-10e). The ECD model 180 (details shown in FIG. 7C) emulates the ECD 124, receives optional inputs from the main controller 170 via control and data line 26, receives optional inputs from the energy source 330, outputs a set voltage profile (SVP) to the comparator 322 and the voltage compensator 326, outputs an adjusted voltage profile to another input of the comparator 322 and an input of the voltage profile switch 328. The energy source 330 can have a battery system, a photovoltaic cell system, and/or an electrical generator system, for supplying power to the ECD model 180 and thus the ECD 124 either directly or indirectly. The comparator 322 compares two voltage profiles on its inputs and can communicate the comparison results to the IGU processor 320 via line 10c. The IGU processor 320 can process the comparison results or send the comparison results to the voltage compensator calculator 324 for processing. The IGU processor 320 or the voltage compensator calculator 324 can calculate compensation parameters for the ECD 124 such that when standard SVPs are input to the IGU, then the ECD in the IGU will produce the standard DTP from the compensated voltage profile. The compensation parameters can be stored in the voltage compensator 326 for application to SVPs as they are received by the IGU 200. The switch 328 can control which circuitry supplies the voltage profile that is output to the ECD 124 for producing the tint profile in the ECD.

The IGU controller 176 can be used to characterize the ECD 124 and produce custom voltage compensation parameters used to cause the ECD 124 to produce a DTP from a corresponding SVP when the SVP is received by the IGU controller 176. To characterize an ECD 124, the ECD model 180 begins with initial values for the modeling parameters (i.e. R11, R12, R13, R21, R22, R23, Rg1, Rg2, Rg3, Rg4, Rg5, Rg6, and capacitors C1, C2, Cg1, Cg2). A test voltage profile can be received from the main controller 170 or the energy source 330 and output from the ECD model 180 to both the comparator 322 and the switch 328 via line 14. The test voltage profile can be equal to a first SVP that is configured to produce a first DTP in an ECD that has been characterized. However, since this ECD 124 has not yet been characterized, the first SVP can be used in the characterization process.

At the beginning of the ECD characterization process, no compensation parameters have been calculated. Therefore, the switch 328 selects the inputs from the ECD model 180 to drive the voltage supply terminals V1, V2, V3, V4 of the ECD 124. The initial voltage profile output to the ECD 124 can be the first SVP. Using a test system, such as the test system 210 shown in FIG. 8, the % transmission level (or % tint level) across the ECD 124 can be determined when the test voltage profile (initially the first SVP) is applied to the ECD 124. By testing the % transmission level across the ECD 124, a test tint profile can be established. By an iterative process of adjusting the test voltage profile output from the ECD model 180 and testing the % transmission level across the ECD 124, the tint profile of the ECD can be adjusted to substantially match the first DTP which is associated with the first SVP. When the tint profile substantially matches the first DTP, the ECD model 180 can output the adjusted voltage profile to one comparator input and output the first SVP to the other comparator input.

The comparator 322 can analyze the two voltage profiles and communicate the comparison results to the IGU processor 320 via line 10c. The IGU processor 320 can determine the unique values for the modeling parameters (i.e. R11, R12, R13, R21, R22, R23, Rg1, Rg2, Rg3, Rg4, Rg5, Rg6, and capacitors C1, C2, Cg1, Cg2) from the comparison results as well as the adjusted and set voltage profiles. The IGU processor 320 can output the unique values of the modeling parameters to the ECD model 180, which can insert these values in the ECD model to personalize the ECD model to emulate the ECD 124. By running the ECD model 180, the IGU processor 320 can calculate voltage compensation parameters or transmit the necessary data (such as voltages and currents in the ECD model 180 when the first SVP is received at the ECD model 180 inputs) to the voltage compensator calculator 324, which can calculate the voltage compensation parameters. The voltage compensation parameters can be transmitted to the voltage compensator 326, which can automatically adjust a voltage profile on its inputs to a compensated voltage profile (CVP) on its outputs.

Now that the voltage compensation parameters are determined, the switch 328 can select the CVP output from the voltage compensator 326 via line 20. The main controller 170 can then transmit a first SVP to the inputs of the ECD model 180 which can send a voltage profile to the voltage compensator 326 via line 12b. The voltage compensator 326 can apply the voltage compensation parameters to the input voltage profile and output the CVP to the switch 328 via line 20. With the switch selecting the line 20, the CVP is applied to the ECD 124, which will produce a tint profile that substantially matches the first DTP.

If the main controller 170 transmits a second SVP to the inputs of the ECD model 180, a voltage profile will be output to the voltage compensator 326 via line 12b. The voltage compensator 326 can apply the voltage compensation parameters to the input voltage profile and output the CVP to the switch 328 via line 20. With the switch selecting the line 20, the CVP is applied to the ECD 124, which will produce a tint profile that substantially matches a second DTP that corresponds to the second SVP.

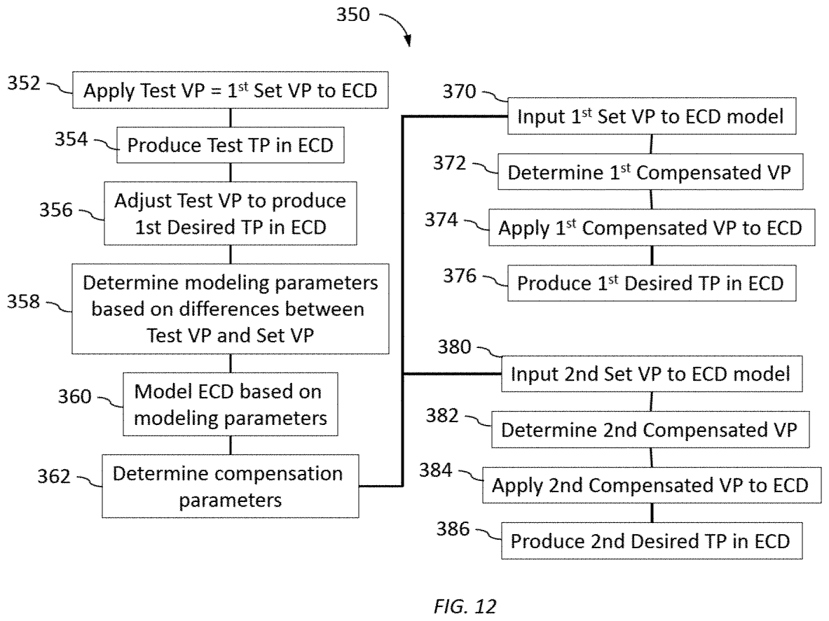

FIG. 12 includes a representative flow chart of the process (or method) 350 for characterizing an IGU using an ECD model and producing desired tint profiles in the ECD, according to one embodiment. In operation 352, a test voltage profile (that is initially equal to the first SVP) is applied to the ECD. In operation 354, the test voltage profile produces a test tint profile in the ECD. In operation 356, the test voltage profile is adjusted to produce a first DTP in the ECD. In operation 358, the modeling parameters are determined based on a comparison between the adjusted voltage profile and the first SVP. In operation 360, the modeling parameters are used to model the ECD. In operation 362, voltage compensation parameters are determined. In operation 370, the first SVP is applied to the ECD model. In operation 372, a CVP is calculated based on the first SVP and the voltage compensation parameters. In operation 374, the CVP is applied to the ECD 124. In operation 276, the CVP produces the first DTP in the ECD 124.

The same voltage compensation parameters can be used to produce other DTPs. For example, in operation 380, the second SVP is applied to the ECD model. In operation 372, a CVP is calculated based on the second SVP and the voltage compensation parameters. In operation 374, the CVP is applied to the ECD 124. In operation 276, the CVP produces the second DTP in the ECD 124.

Many different aspects and embodiments are possible. Some of those aspects and embodiments are described below. Exemplary embodiments may be in accordance with any one or more of the ones as listed below.

### EMBODIMENTS

Embodiment 1. A method for controlling multiple insulated glass units (IGUs), with each IGU having an electrochromic device (ECD) with a variable tint profile, the method comprising: applying a test voltage profile to four or more bus bars of a first ECD in a first IGU; producing a first test tint profile in the first ECD in response to the test voltage profile, with the test voltage profile initially being equal to a first set voltage profile (SVP); adjusting the test voltage profile to produce a first desired tint profile (DTP) in the first ECD; determining first modeling parameters based on differences between the first SVP and the adjusted test voltage profile for the first ECD; modeling the first ECD, via a first ECD model, based on the first modeling parameters; determining first compensation parameters via the first ECD model; inputting the first SVP to the first ECD model; determining a first compensated voltage profile (CVP) by modifying the first SVP based on the first compensation parameters; and applying the first CVP to the bus bars of the first ECD; and producing the first DTP in the first ECD of the first IGU in response to applying the first CVP to the first ECD.

Embodiment 2. The method of embodiment 1, further comprising: applying the test voltage profile to four or more bus bars of a second ECD in a second IGU; producing a second test tint profile in the second ECD in response to the test voltage profile, with the test voltage profile initially being equal to the first SVP; adjusting the test voltage profile to produce the first DTP in the second ECD; determining second modeling parameters based on differences between the first SVP and the adjusted test voltage profile for the second ECD; modeling the second ECD, via a second ECD model, based on the second modeling parameters; determining second compensation parameters via the second ECD model; inputting the first SVP to the second ECD model; determining a second CVP by modifying the first SVP based on the second compensation parameters; and applying the second CVP to the bus bars of the second ECD; and producing the first DTP in the second ECD of the second IGU in response to applying the second CVP to the second ECD.

Embodiment 3. The method of embodiment 2, further comprising: inputting a second SVP to the first ECD model; determining a third CVP by modifying the second SVP based on the first compensation parameters; applying the third CVP to the bus bars of the first ECD; and producing a second DTP in the first ECD of the first IGU in response to applying the third CVP to the first ECD.

Embodiment 4. The method of embodiment 3, further comprising: inputting the second SVP to the second ECD model; determining a fourth CVP by modifying the second SVP based on the second compensation parameters; applying the fourth CVP to the bus bars of the second ECD; and producing the second DTP in the second ECD of the second IGU in response to applying the fourth CVP to the second ECD.

Embodiment 5. The method of embodiment 3, wherein the first DTP is a gradient tint profile, wherein the gradient tint profile comprises a tint level in one area of the first ECD that is different than a tint level in another area of the first ECD.

Embodiment 6. The method of embodiment 5, wherein the gradient tint profile transitions from a full tint level at a top of the first ECD to a full clear level at a bottom of the first ECD.

Embodiment 7. The method of embodiment 5, wherein the gradient tint profile transitions from a 10% tint level at a top of the first ECD to a full clear level at a bottom of the first ECD.

Embodiment 8. The method of embodiment 5, wherein the gradient tint profile transitions from a 10% tint level at a top of the first ECD to a full tint level at a bottom of the first ECD.

Embodiment 9. The method of embodiment 1, wherein the first modeling parameters comprise: a configuration of the bus bars in the first ECD, an impedance of each of the bus bars, a sheet resistance of each conductive layer of the first ECD, a size of the first ECD, a temperature of the first ECD, a desired tint level of the first ECD, voltage differences between the bus bars, estimated current supplied to the bus bars, or combinations thereof.

Embodiment 10. The method of embodiment 9, wherein the first ECD comprises top and bottom zones, with at least first and third bus bars positioned in the top zone, and at least second and fourth bus bars positioned in the bottom zone.

Embodiment 11. The method of embodiment 10, wherein the top and bottom zones share conductive layers of the first ECD, such that current flows in the top zone between the first and third bus bars, current flows in the bottom zone between the second and fourth bus bars, current flows between the top zone and the bottom zone, or combinations thereof.

Embodiment 12. The method of embodiment 11, wherein the first ECD model estimates the currents that flow in the top zone, in the bottom zone, and between the top and bottom zones.

Embodiment 13. The method of embodiment 11, wherein the current that flows between the top zone and the bottom zone is a gradient formation leakage current, and wherein the first ECD model predicts the gradient formation leakage current.

Embodiment 14. The method of embodiment 9, further comprising an ECD controller receiving one of more of the first modeling parameters from a main controller, a non-transitory memory storage, sensors, or combinations thereof.

Embodiment 15. The method of embodiment 14, wherein the one or more of the first modeling parameters received by the ECD controller comprise: the configuration of the bus bars in the first ECD, the impedance of each of the bus bars, the sheet resistance of each conductive layer of the first ECD, the size of the first ECD, the temperature of the first ECD, a desired tint level of the first ECD, or combinations thereof.

Embodiment 16. The method of embodiment 9, further comprising an ECD controller calculating one of more of the first modeling parameters, the one or more of the first modeling parameters comprising voltage differences between the bus bars, the estimated current supplied to the bus bars, or a combination thereof.

Embodiment 17. The method of embodiment 16, wherein the temperature of the first ECD is collected via a temperature sensor and transferred to the ECD controller, wherein the temperature of the first ECD is updated in real-time, and wherein the one or more of the first modeling parameters are updated based on changes in the temperature of the first ECD.

Embodiment 18. The method of embodiment 1, wherein the first ECD model is an equivalent impedance model that establishes an equivalent impedance for each of multiple pairs of bus bars of the at least four or more bus bars.

Embodiment 19. A method for controlling multiple electrochromic devices (ECDs) with each having a variable tint profile, the method comprising: applying an initial test voltage profile to four or more bus bars of a first ECD; producing a first test tint profile in the first ECD in response to the initial test voltage profile; adjusting the initial test voltage profile to produce a first desired tint profile (DTP) in the first ECD; determining first modeling parameters based on the adjustments of the initial test voltage profile; modeling the first ECD, via a first ECD model, based on the first modeling parameters; determining first compensation parameters via the first ECD model; determining a first compensated voltage profile (CVP) by modifying the initial test voltage profile based on the first compensation parameters; and producing the first DTP in the first ECD in response to applying the first CVP to the first ECD.

Embodiment 20. The method of embodiment 19, further comprising: applying the initial test voltage profile to four or more bus bars of a second ECD; producing a second test tint profile in the second ECD in response to the initial test voltage profile; adjusting the test voltage profile to produce the first DTP in the second ECD; determining second modeling parameters based on the adjustments of the initial test voltage profile; modeling the second ECD, via a second ECD model, based on the second modeling parameters; determining second compensation parameters via the second ECD model; determining a second CVP by modifying the initial test voltage profile based on the second compensation parameters; and producing the first DTP in the second ECD in response to applying the second CVP to the second ECD.

Embodiment 21. The method of embodiment 20, further comprising: inputting a first set voltage profile (SVP) to the first ECD model; determining a third CVP by modifying the first SVP based on the first compensation parameters; applying the third CVP to the bus bars of the first ECD; and producing a second DTP in the first ECD in response to applying the third CVP to the first ECD.

Embodiment 22. The method of embodiment 21, further comprising: inputting the first SVP to the second ECD model; determining a fourth CVP by modifying the first SVP based on the second compensation parameters; applying the fourth CVP to the bus bars of the second ECD; and producing the second DTP in the second ECD in response to applying the fourth CVP to the second ECD.

Embodiment 23. The method of embodiment 21, wherein the first DTP or the second DTP is a gradient tint profile, wherein the gradient tint profile comprises a tint level in one area of the first ECD that is different than a tint level in another area of the first ECD, and wherein an ECD controller can switch the ECD from the first DTP to the second DTP.

Embodiment 24. The method of embodiment 23, wherein the gradient tint profile transitions from a full tint level at a top of the first ECD to a full clear level at a bottom of the first ECD.

Embodiment 25. The method of embodiment 23, wherein the gradient tint profile transitions from a 10% tint level at a top of the first ECD to a full clear level at a bottom of the first ECD.

Embodiment 26. The method of embodiment 23, wherein the gradient tint profile transitions from a 10% tint level at a top of the first ECD to a full tint level at a bottom of the first ECD.

Embodiment 27. The method of embodiment 23, wherein the gradient tint profile transitions from a tint level that is full clear, 62%, 61%, 60%, 55%, 50%, 45%, 40%, 35%, 30%, 25%, 20%, 15%, 14%, 13%, 12%, 11%, 10%, 9%, 8%, 7%, 6%, 5%, 4%, 3%, or 2% transmission level at the top of the first ECD to a full tint level at a bottom of the first ECD.

Embodiment 28. The method of embodiment 23, wherein the gradient tint profile transitions from a tint level that is full clear, 62%, 61%, 60%, 55%, 50%, 45%, 40%, 35%, 30%, 25%, 20%, 15%, 14%, 13%, 12%, 11%, 10%, 9%, 8%, 7%, 6%, 5%, 4%, 3%, or 2% transmission level at the top 20% of the first ECD to a full tint level at a bottom 20% of the first ECD.

Embodiment 29. The method of embodiment 23, wherein the gradient tint profile transitions from a tint level that is full clear, 62%, 61%, 60%, 55%, 50%, 45%, 40%, 35%, 30%, 25%, 20%, 15%, 14%, 13%, 12%, 11%, 10%, 9%, 8%, 7%, 6%, 5%, 4%, 3%, or 2% transmission level at the top 20% of the first ECD to a full tint level at a bottom of the first ECD.30.

Embodiment 30. The method of embodiment 23, wherein the gradient tint profile transitions from a full tint level at a top of the first ECD to a tint level that is full clear, 62%, 61%, 60%, 55%, 50%, 45%, 40%, 35%, 30%, 25%, 20%, 15%, 14%, 13%, 12%, 11%, 10%, 9%, 8%, 7%, 6%, 5%, 4%, 3%, or 2% transmission level at a bottom of the first ECD.

Embodiment 31. The method of embodiment 23, wherein the gradient tint profile transitions from a full tint level at a top 20% of the first ECD to a tint level that is full clear, 62%, 61%, 60%, 55%, 50%, 45%, 40%, 35%, 30%, 25%, 20%, 15%, 14%, 13%, 12%, 11%, 10%, 9%, 8%, 7%, 6%, 5%, 4%, 3%, or 2% transmission level at a bottom 20% of the first ECD.

Embodiment 32. The method of embodiment 23, wherein the gradient tint profile transitions from a full tint level at a top 20% of the first ECD to a tint level that is full clear, 62%, 61%, 60%, 55%, 50%, 45%, 40%, 35%, 30%, 25%, 20%, 15%, 14%, 13%, 12%, 11%, 10%, 9%, 8%, 7%, 6%, 5%, 4%, 3%, or 2% transmission level at a bottom of the first ECD.

Embodiment 33. The method of embodiment 23, wherein the gradient tint profile transitions from a full tint level at a bottom left corner of the first ECD to a tint level that is full clear, 62%, 61%, 60%, 55%, 50%, 45%, 40%, 35%, 30%, 25%, 20%, 15%, 14%, 13%, 12%, 11%, 10%, 9%, 8%, 7%, 6%, 5%, 4%, 3%, or 2% transmission level at a top right corner of the first ECD.

Embodiment 34. The method of embodiment 23, wherein the gradient tint profile transitions from a tint level that is full clear, 62%, 61%, 60%, 55%, 50%, 45%, 40%, 35%, 30%, 25%, 20%, 15%, 14%, 13%, 12%, 11%, 10%, 9%, 8%, 7%, 6%, 5%, 4%, 3%, or 2% transmission level at a bottom left corner of the first ECD to a full tint level at a top right corner of the first ECD.

Embodiment 35. The method of embodiment 23, wherein the gradient tint profile transitions from a full tint level at a top left corner of the first ECD to a tint level that is full clear, 62%, 61%, 60%, 55%, 50%, 45%, 40%, 35%, 30%, 25%, 20%, 15%, 14%, 13%, 12%, 11%, 10%, 9%, 8%, 7%, 6%, 5%, 4%, 3%, or 2% transmission level at a bottom right corner of the first ECD.

Embodiment 36. The method of embodiment 23, wherein the gradient tint profile transitions from a tint level that is full clear, 62%, 61%, 60%, 55%, 50%, 45%, 40%, 35%, 30%, 25%, 20%, 15%, 14%, 13%, 12%, 11%, 10%, 9%, 8%, 7%, 6%, 5%, 4%, 3%, or 2% transmission level at a bottom left corner of the first ECD to a full tint level at a top right corner of the first ECD.

Embodiment 37. The method of embodiment 21, wherein the first DTP or the second DTP can have a fully clear tint, have a fully tinted profile, have a partially tinted profile, have a substantially uniform tint level across the ECD, have a continuously graded tint level across the ECD, or have a combination of a portion with a substantially uniform tint level and another portion with a continuously graded tint level.

Embodiment 38. The method of embodiment 19, wherein the first modeling parameters comprise: a configuration of the bus bars in the first ECD, an impedance of each of the bus bars, a sheet resistance of each conductive layer of the first ECD, a size of the first ECD, a temperature of the first ECD, a desired tint level of the first ECD, voltage differences between the bus bars, estimated current supplied to the bus bars, or combinations thereof.

Embodiment 39. The method of embodiment 38, wherein the first ECD comprises top and bottom zones, with at least first and third bus bars positioned in the top zone, and at least second and fourth bus bars positioned in the bottom zone.

Embodiment 40. The method of embodiment 39, wherein the top and bottom zones share conductive layers of the first ECD, such that current flows in the top zone between the first and third bus bars, current flows in the bottom zone between the second and fourth bus bars, current flows between the top zone and the bottom zone, or combinations thereof.

Embodiment 41. The method of embodiment 40, wherein the first ECD model estimates the currents that flow in the top zone, in the bottom zone, and between the top and bottom zones.

Embodiment 42. The method of embodiment 40, wherein the current that flows between the top zone and the bottom zone is a gradient formation leakage current, and wherein the first ECD model predicts the gradient formation leakage current.

Embodiment 43. The method of embodiment 38, further comprising an ECD controller receiving one of more of the first modeling parameters from a main controller, a non-transitory memory storage, sensors, or combinations thereof.

Embodiment 44. The method of embodiment 43, wherein the one or more of the first modeling parameters received by the ECD controller comprise: the configuration of the bus bars in the first ECD, the impedance of each of the bus bars, the sheet resistance of each conductive layer of the first ECD, the size of the first ECD, the temperature of the first ECD, a desired tint level of the first ECD, or combinations thereof.

Embodiment 45. The method of embodiment 38, further comprising an ECD controller calculating one of more of the first modeling parameters, the one or more of the first modeling parameters comprising voltage differences between the bus bars, the estimated current supplied to the bus bars, or a combination thereof.

Embodiment 46. The method of embodiment 45, wherein the temperature of the first ECD is collected via a temperature sensor and transferred to the ECD controller, wherein the temperature of the first ECD is updated in real-time, and wherein the one or more of the first modeling parameters are updated based on changes in the temperature of the first ECD.

Embodiment 47. The method of embodiment 19, wherein the first ECD model is an equivalent impedance model that establishes an equivalent impedance for each of multiple pairs of bus bars of the at least four or more bus bars.

While the present disclosure may be susceptible to various modifications and alternative forms, specific embodiments have been shown by way of example in the drawings and tables and have been described in detail herein. However, it should be understood that the embodiments are not intended to be limited to the particular forms disclosed. Rather, the disclosure is to cover all modifications, equivalents, and alternatives falling within the spirit and scope of the disclosure as defined by the following appended claims. Further, although individual embodiments are discussed herein, the disclosure is intended to cover all combinations of these embodiments.

Note that not all of the activities described above in the general description or the examples are required, that a portion of a specific activity may not be required, and that one or more further activities may be performed in addition to those described. Still further, the order in which activities are listed is not necessarily the order in which they are performed.

Certain features that are, for clarity, described herein in the context of separate embodiments, may also be provided in combination in a single embodiment. Conversely, various features that are, for brevity, described in the context of a single embodiment, may also be provided separately or in any sub-combination. Further, reference to values stated in ranges includes each and every value within that range.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any sub-combination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

What is claimed is:

1. A method for controlling multiple insulated glass units (IGUs), with each IGU having an electrochromic device (ECD) with a variable tint profile, the method comprising:
applying a test voltage profile to four or more bus bars of a first ECD in a first IGU;
producing a first test tint profile in the first ECD in response to the test voltage profile, with the test voltage profile initially being equal to a first set voltage profile (SVP);
adjusting the test voltage profile to produce a first desired tint profile (DTP) in the first ECD;
determining first modeling parameters based on differences between the first SVP and the adjusted test voltage profile for the first ECD;
modeling the first ECD, via a first ECD model, based on the first modeling parameters;
determining first compensation parameters via the first ECD model;
inputting the first SVP to the first ECD model;
determining a first compensated voltage profile (CVP) by modifying the first SVP based on the first compensation parameters; and
applying the first CVP to the bus bars of the first ECD; and
producing the first DTP in the first ECD of the first IGU in response to applying the first CVP to the first ECD.

2. The method of claim 1, further comprising:
applying the test voltage profile to four or more bus bars of a second ECD in a second IGU;
producing a second test tint profile in the second ECD in response to the test voltage profile, with the test voltage profile initially being equal to the first SVP;
adjusting the test voltage profile to produce the first DTP in the second ECD;
determining second modeling parameters based on differences between the first SVP and the adjusted test voltage profile for the second ECD;
modeling the second ECD, via a second ECD model, based on the second modeling parameters;
determining second compensation parameters via the second ECD model;
inputting the first SVP to the second ECD model;
determining a second CVP by modifying the first SVP based on the second compensation parameters; and
applying the second CVP to the bus bars of the second ECD; and
producing the first DTP in the second ECD of the second IGU in response to applying the second CVP to the second ECD.

3. The method of claim 2, further comprising:
inputting a second SVP to the first ECD model;
determining a third CVP by modifying the second SVP based on the first compensation parameters;
applying the third CVP to the bus bars of the first ECD; and
producing a second DTP in the first ECD of the first IGU in response to applying the third CVP to the first ECD.

4. The method of claim 3, further comprising:
inputting the second SVP to the second ECD model;
determining a fourth CVP by modifying the second SVP based on the second compensation parameters;
applying the fourth CVP to the bus bars of the second ECD; and
producing the second DTP in the second ECD of the second IGU in response to applying the fourth CVP to the second ECD.

5. The method of claim 3, wherein the first DTP is a gradient tint profile, wherein the gradient tint profile comprises a tint level in one area of the first ECD that is different than a tint level in another area of the first ECD.

6. The method of claim 5, wherein the gradient tint profile transitions from a full tint level at a top of the first ECD to a full clear level at a bottom of the first ECD.

7. The method of claim 1, wherein the first modeling parameters comprise:
a configuration of the bus bars in the first ECD,
an impedance of each of the bus bars,
a sheet resistance of each conductive layer of the first ECD,
a size of the first ECD,
a temperature of the first ECD,
a desired tint level of the first ECD,
voltage differences between the bus bars,
estimated current supplied to the bus bars, or
combinations thereof.

8. The method of claim 7, wherein the first ECD comprises top and bottom zones, with at least first and third bus bars positioned in the top zone, and at least second and fourth bus bars positioned in the bottom zone.

9. The method of claim 8, wherein the top and bottom zones share conductive layers of the first ECD, such that current flows in the top zone between the first and third bus bars, current flows in the bottom zone between the second and fourth bus bars, current flows between the top zone and the bottom zone, or combinations thereof.

10. The method of claim 9, wherein the first ECD model estimates the currents that flow in the top zone, in the bottom zone, and between the top and bottom zones.

11. A method for controlling multiple electrochromic devices (ECDs) with each having a variable tint profile, the method comprising:
applying an initial test voltage profile to four or more bus bars of a first ECD;
producing a first test tint profile in the first ECD in response to the initial test voltage profile;
adjusting the initial test voltage profile to produce a first desired tint profile (DTP) in the first ECD;
determining first modeling parameters based on the adjustments of the initial test voltage profile;
modeling the first ECD, via a first ECD model, based on the first modeling parameters;
determining first compensation parameters via the first ECD model;
determining a first compensated voltage profile (CVP) by modifying the initial test voltage profile based on the first compensation parameters; and
producing the first DTP in the first ECD in response to applying the first CVP to the first ECD.

12. The method of claim 11, further comprising:
applying the initial test voltage profile to four or more bus bars of a second ECD;
producing a second test tint profile in the second ECD in response to the initial test voltage profile;
adjusting the test voltage profile to produce the first DTP in the second ECD;
determining second modeling parameters based on the adjustments of the initial test voltage profile;
modeling the second ECD, via a second ECD model, based on the second modeling parameters;
determining second compensation parameters via the second ECD model;
determining a second CVP by modifying the initial test voltage profile based on the second compensation parameters; and
producing the first DTP in the second ECD in response to applying the second CVP to the second ECD.

13. The method of claim 12, further comprising:
inputting a first set voltage profile (SVP) to the first ECD model;
determining a third CVP by modifying the first SVP based on the first compensation parameters;
applying the third CVP to the bus bars of the first ECD; and
producing a second DTP in the first ECD in response to applying the third CVP to the first ECD.

14. The method of claim 13, further comprising:
inputting the first SVP to the second ECD model;
determining a fourth CVP by modifying the first SVP based on the second compensation parameters;
applying the fourth CVP to the bus bars of the second ECD; and
producing the second DTP in the second ECD in response to applying the fourth CVP to the second ECD.

15. The method of claim 11, wherein the gradient tint profile transitions from a 10% tint level at a top of the first ECD to a full tint level at a bottom of the first ECD.

16. The method of claim 11, wherein the gradient tint profile transitions from a tint level that is at least 62% transmission level at the top 20% of the first ECD to a full tint level at a bottom 20% of the first ECD.

17. A method for controlling multiple electrochromic devices (ECDs) with each having a variable tint profile, the method comprising:
applying an initial test voltage profile to four or more bus bars of a first ECD;
producing a first test tint profile in the first ECD in response to the initial test voltage profile;
adjusting the initial test voltage profile to produce a first desired tint profile (DTP) in the first ECD;
determining first modeling parameters based on the adjustments of the initial test voltage profile wherein the first modeling parameters comprise:
a configuration of the bus bars in the first ECD,
an impedance of each of the bus bars,
a sheet resistance of each conductive layer of the first ECD,
a size of the first ECD,
a temperature of the first ECD,
a desired tint level of the first ECD,
voltage differences between the bus bars,
estimated current supplied to the bus bars, or
combinations thereof;
modeling the first ECD, via a first ECD model, based on the first modeling parameters;
determining first compensation parameters via the first ECD model;
determining a first compensated voltage profile (CVP) by modifying the initial test voltage profile based on the first compensation parameters; and
producing the first DTP in the first ECD in response to applying the first CVP to the first ECD.

18. The method of claim 17, wherein the first ECD comprises top and bottom zones, with at least first and third bus bars positioned in the top zone, and at least second and fourth bus bars positioned in the bottom zone.

19. The method of claim 18, wherein the top and bottom zones share conductive layers of the first ECD, such that current flows in the top zone between the first and third bus bars, current flows in the bottom zone between the second and fourth bus bars, current flows between the top zone and the bottom zone, or combinations thereof.

20. The method of claim 19, wherein the first ECD model estimates the currents that flow in the top zone, in the bottom zone, and between the top and bottom zones.
